(19) United States
(12) Patent Application Publication
(10) Pub. No.: US 2021/0097617 A1
(43) Pub. Date: Apr. 1, 2021

(54) METHODS AND SYSTEMS FOR SECURITIZATION OF CDs APPLICABLE TO CREDIT UNIONS

(71) Applicant: Robert C. Colvin, Leawood, KS (US)

(72) Inventor: Robert C. Colvin, Leawood, KS (US)

(21) Appl. No.: 17/032,182

(22) Filed: Sep. 25, 2020

Related U.S. Application Data
(60) Provisional application No. 62/906,849, filed on Sep. 27, 2019.

(51) Int. Cl. G06Q 40/06; G06Q 40/02

(52) U.S. Cl. CPC G06Q 40/06; G06Q 40/02

(57) ABSTRACT

Systems and methods for facilitating capital markets funding include maintaining a database of information corresponding to a plurality of credit unions, fields of membership for the credit unions, share certificate orders, and depositor LLCs associated with the share certificate orders. The fields of membership are categorized and credit unions interested in participating in a capital markets offering are identified. Some of the fields of membership may be modified to allow the depositor LLCs to become members of the participating credit unions. Confirmed share certificate orders are logged and share certificates are associated with corresponding participating credit unions. Data relating to each share certificate is tracked for the life of the share certificate.

### RELATED APPLICATIONS

This patent application is a regular utility non-provisional application, and claims priority benefit with regard to all common subject matter, of earlier-filed U.S. Provisional Patent Application Ser. No. 62/906,849, filed on Sep. 27, 2019, and entitled “METHODS AND SYSTEMS FOR SECURITIZATION OF CDs APPLICABLE TO CREDIT UNIONS”. The identified earlier-filed provisional patent application is hereby incorporated by reference in its entirety into the present application.

### BACKGROUND

Capital markets funding for credit unions cannot be achieved the same way as in the banking industry. For example, one difference in the issuance of capital market certificates of deposit (CMCD) notes secured with certificates of deposit (CDs) issued by credit unions as opposed to FDIC insured banks is the process in which the CDs are purchased. For the banking industry, it is possible to for a CMCD manager to purchase CDs from any group of interested banks that wanted to participate. The location of the manager and the relationship between the manager and the participating bank is irrelevant.

Unlike banks that are open to anyone, opening an account at a credit union is a selective process. To purchase a CD from a credit union, the buyer must first be a member of the credit union. Certain laws require credit unions to have a defined field of membership, which means an interested party has to be a member of a credit union's defined group to access the credit union and its services. The field of membership can be broad, such as an employer, church, school, or community that may include an entire city, but each of the more than 5,000 credit unions is different and therefore the task of joining each credit union is a significant task.

This background discussion is intended to provide information related to the present invention which is not necessarily prior art.

### SUMMARY

Embodiments of the present invention solve the above-described and other problems by providing a system and computer-implemented method for facilitating capital markets funding for credit unions.

An embodiment of the present invention involves issuing secured debt securities (Capital Market Notes) to Investors in privately placed capital markets offerings. The Capital Market Notes may be issued by a special purpose vehicle, with the net proceeds from each offering used to purchase Depositor Notes from a number of Depositor LLCs. The Depositor LLCs may then use the proceeds received from the sale of the Depositor Notes to directly purchase Share Certificates from Participating Credit Unions.

To facilitate this capital markets funding, an Administrator may periodically communicate with credit unions that satisfy certain eligibility criteria to participate about the credit unions' funding plans, the indicative terms for raising funds, and whether each credit union would be interested in participating in the next offering. Participating Credit Unions may agree to sell Share Certificates with a face amount (including accrued interest) not exceeding a standard maximum share insurance amount (SMSIA) to one or more Depositor LLCs.

To finance the purchase of the Share Certificates, each Depositor LLC may issue and sell a Depositor Note to an Issuer. The Depositor Note may be secured by such depositor LLC's Funding Pool. To finance the purchase of the Depositor Notes, the Issuer may issue Capital Market Notes to the Investors. The Capital Market Notes may be secured by the Depositor Notes and the Issuer's secured interest in each depositor LLCs Funding Pool.

The field of membership for each Participating Credit Union may be categorized in a database and then modified if needed to allow for each of the Depositor LLCs to become a member of each of the Participating Credit Unions. The modification may require the submission of a specific form that must meet National Credit Union Administration (NCUA) criteria to the Participating Credit Union. The submission and acceptance receipt of the modified field of membership may be automated by the Administrator and maintained in a database for future reference. This may be required to validate the NCUA insurance available to credit union members.

Offers to purchase Share Certificates from Participating Credit Unions may then be made. Each of the Participating Credit Unions may have the option of issuing Share Certificates in a total amount up to $1,000,000, for example (other amounts may be used). Depending on the amount requested, the order may be segregated into 1-4 separate LLCs so that no one LLC has more than a $250,000 balance to maintain NCUA insurance. Confirmed orders from Participating Credit Unions each month may be logged into the database. The orders may then be separated into an appropriate number of LLCs required to make sure the Share Certificates are fully insured.

The Administrator tracks which Participating Credit Unions have sold Share Certificates via the computerized order allocation system. The database may also be used to identify the Depositor LLC associated with each Share Certificate. The amount, rate, and term of each Share Certificate from each Participating Credit Union may also be tracked so that the insurance coverage for each Depositor LLC can be verified, documented, and tracked over the life of the Share Certificate.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a schematic diagram of an order allocation system constructed in accordance with an embodiment of the invention;

FIG. 2 is a schematic diagram of participating entities of a capital markets funding program for credit unions in accordance with an embodiment of the invention; and

FIG. 3 is a block diagram including certain method steps for facilitating capital markets funding in accordance with an embodiment of the invention.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

The present invention provides a system and computer-implemented method for facilitating capital markets funding for credit unions. The present invention enables share certificates of NCUA insured credit unions to be purchased and pledged as collateral in support of periodic offerings of debt securities in the capital markets.

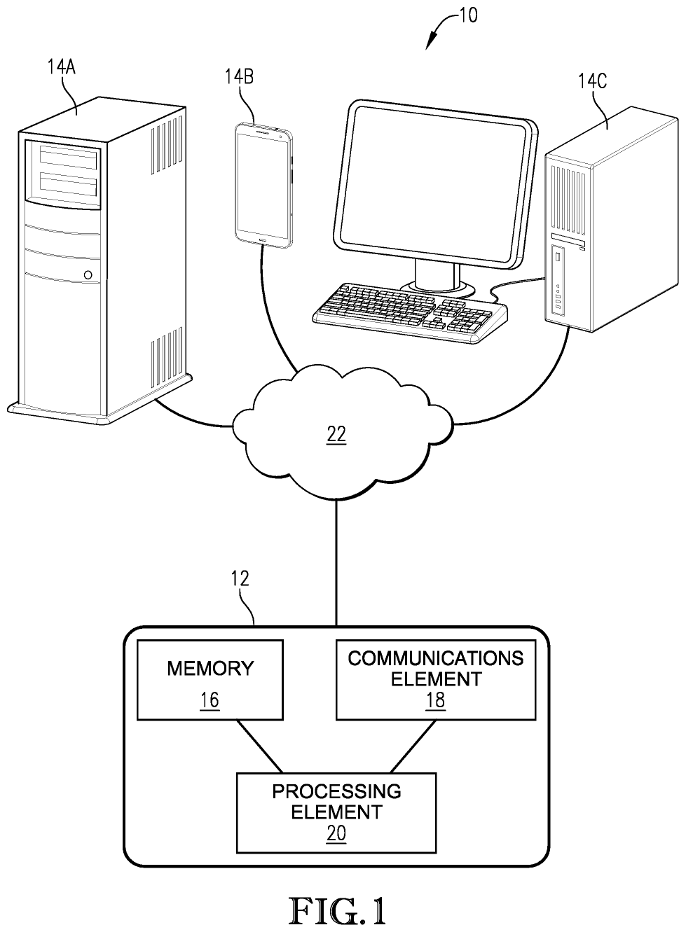

Referring to FIG. 1, a computerized order allocation system 10 in accordance with an embodiment of the invention is shown for facilitating capital markets funding. More particularly, the computerized order allocation system 10 allows an administrator to make offers to purchase share certificates from participating credit unions each month (or quarter) and allows the participating credit unions to accept or deny the offers. The computerized order allocation system 10 broadly comprises a computing device 12 and a plurality of remote computing devices 14A-C.

The computing device 12 includes an electronic memory element 16, an electronic communications element 18, and a processing element 20. The computing device 12 may be any suitable computing device configured to implement an embodiment of the present technology.

The electronic memory element 16 may be any computer-readable non-transitory medium that can store a program for use by or in connection with an instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The electronic communications element 18 allows the processing element 20 to communicate with the remote computing devices 14A-C or other electronic devices via a communications network 22. The electronic communications element 18 may include signal or data transmitting and receiving circuits, such as antennas, amplifiers, filters, mixers, oscillators, digital signal processors (DSPs), and the like.

The processing element 20 may include electronic hardware components such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 20 may generally execute, process, or run instructions, code, code segments, software, firmware, programs, applications, apps, processes, services, daemons, or the like. The processing element 20 may also include hardware components such as finite-state machines, sequential and combinational logic, and other electronic circuits that can perform the functions necessary for the operation of the current invention. The processing element 20 may be in communication with the remote computing devices 14A-C via a wired or wireless communications network.

The remote computing devices 14A-C may be servers, off-site storage units acting as data repositories or cloud computing devices, desktop computers, personal computing devices, and the like. The remote computing devices 14A-C may also include additional or parallel computing devices for detecting fraudulent transactions in different geographical regions, marketplaces, or the like.

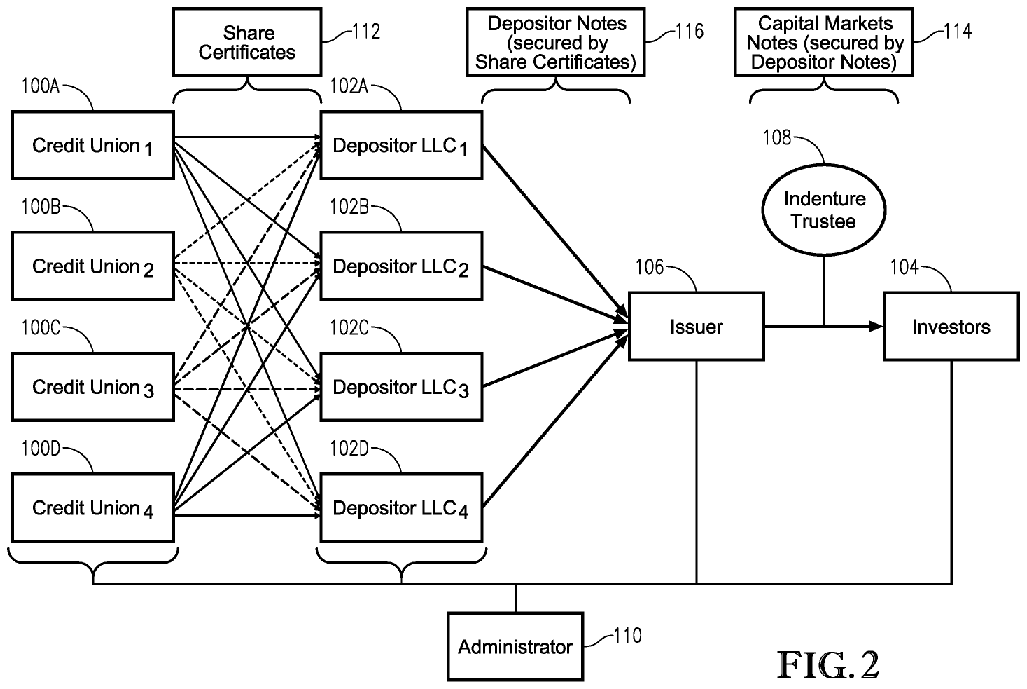

Turning to FIG. 2, embodiments of the present invention involve several parties/entities as defined below. The parties/entities include a plurality of Participating Credit Unions 100A-D, a plurality of Depositor LLCs 102A-D, a plurality of Investors 104, an Issuer 106, an Indenture Trustee 108, and an Administrator 110.

The Participating Credit Unions 100A-D may be federal or state chartered, NCUA-insured credit unions that, at the time of participation in any funding transaction, are “well-capitalized” (as defined under NCUA regulations) and have entered into the documentation to participate in offerings (such as pertains to satisfaction by the applicable Depositor LLCs 102A-D of all membership requirements). Each Participating Credit Union 100A-D may issue Share Certificates 112 in multiple funding transactions and, in a single offering, may issue a separate Share Certificate 112 to each of the multiple Depositor LLCs 102A-D formed for the purpose of participating in that particular offering.

Depositor LLCs 102A-D may be one or more special purpose, bankruptcy-remote, limited liability companies that may be formed in connection with each capital market. Each Depositor LLC 102A-D may have a separate legal existence from each other Depositor LLC 102A-D, the Administrator 110, each Issuer 106, and each Investor 104. The Depositor LLCs 102A-D may be established for and participate in a single capital markets offering. The Administrator 110 may be the sole equity member and manager of each Depositor LLC 102A-D. Multiple Depositor LLCs 102A-D may be formed for each capital markets offering depending on the number of Participating Credit Unions 100A-D that have advised the Administrator 110 that they wish to participate in the next offering and the amount of funds that the Participating Credit Unions 100A-D wish to raise in the offering.

The Investors 104 may be qualified institutional buyers (QIB) as defined in Rule 144A under the Securities Act. Each investor may purchase a beneficial interest in a global note issued by the Issuer 106 in connection with a particular capital markets offering. Each capital markets offering is expected to be marketed to a dedicated investor base that typically invests in high quality assets of this nature. Investors 104 may purchase beneficial interests in Capital Market Notes 114 issued in multiple offerings.

The Issuer 106 may be a special purpose, bankruptcy-remote, limited liability company. Each offering may be associated with a single Issuer 106. The Issuer 106 may have a separate legal existence from the Administrator 110, each Depositor LLC 102A-D, and each Investor 104. The Administrator 110 may be the sole equity member and manager of the Issuer 106.

The Indenture Trustee 108 hold the Capital Market Notes 114 on behalf of the Investors 104. All payments to the Investors 104 of principal of, and interest on, the Capital Market Notes 114 may be made by the Issuer 106 at the direction of the Indenture Trustee 108. The source of funds to make regularly scheduled payments of interest on, and the payment of principal on the stated maturity date of, the Capital Market Notes 114 may be payments of principal and interest received by the Issuer 106 from the Depositor LLCs 102A-D under the Depositor Notes, which will in turn depend on payments of principal and interest received by the Depositor LLCs 102A-D from the Funding Pool.

The Administrator 110 may be an independent entity that is the sole manager of each Depositor LLC 102A-D and each Issuer 106 and may at times maintain a separate legal existence from each Depositor LLC 102A-D, each Issuer 106, and each Investor. The Administrator 110 may be responsible for managing and implementing the method described herein including, among other things, i) setting up and managing the Depositor LLCs 102A-D and each Issuer 106, ii) assisting the Depositor LLCs 102A-D to become members of each of the Participating Credit Unions 100A-D, iii) communicating on a regular basis with Participating Credit Unions 100A-D in order to determine their interest in raising funds via the method described herein, iv) communicating on a regular basis with other credit unions to determine if they are eligible to become a participating credit union and, if so, their level of interest in raising funds by participating, and v) facilitating the purchase by the Depositor LLCs 102A-D of Share Certificates 112 from Participating Credit Unions with the proceeds from the sale of secured notes (Depositor Notes 116).

Securitizing certificates of deposit in connection with Participating Credit Unions 100A-D may involve issuing secured debt securities (Capital Market Notes 114) to Investors 104 in privately placed capital markets offerings under Rule 144A or one of the other exemptions from registration provided for in the Securities Act of 1933, as amended, and the Securities and Exchange Commission's rules promulgated thereunder. On the other hand, if transaction sizes are large enough, registered offerings may be issued. The Capital Market Notes 114 may be issued by a special purpose vehicle, with the net proceeds from each offering used to purchase the Depositor Notes 116 from the Depositor LLCs 102A-D. The Depositor LLCs 102A-D may then use the proceeds received from the sale of the Depositor Notes 116 to directly purchase Share Certificates 112 from Participating Credit Unions 100A-D that, prior to commencement of each periodic capital markets offering, affirmatively expressed a desire to the Administrator 110 to raise funding by participating in the next such offering. Accordingly, the first step of every periodic capital markets offering may be for Participating Credit Unions 100A-D to have indicated to the Administrator 110 that they wish to collectively raise a sufficient amount of funding necessary to facilitate a successful offering. In the absence of such indication of interest from Participating Credit Unions 100A-D, no capital markets offering may take place.

The use of both the Issuer 106 and the Depositor LLCs 102A-D is necessary to facilitate the ability of a Participating Credit Union 100A-D to issue multiple Share Certificates 112, each up to the SMSIA, as part of a single capital markets offering. In the absence of this structure, Investors 104 would be required to purchase smaller notes issued by each individual Depositor LLC 102A-D, which smaller notes are unlikely to have the minimum size and liquidity profile necessary to achieve a successful capital markets offering. The number of depositor LLCs that may be formed in connection with each capital markets offering may depend on the number of Participating Credit Unions 100A-D that have advised the Administrator 110 they wish to participate in the next offering and the amount of funding that the Participating Credit Unions 100A-D wish to raise in the offering. This ensures no single Depositor LLC 102A-D exceeds the SMSIA for an individual Participating Credit Union 100A-D.

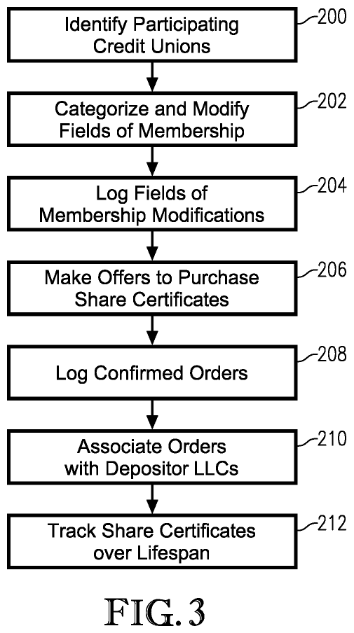

Turning to FIG. 3, and with reference to FIGS. 1 and 2, a method of facilitating capital markets funding with credit unions will now be described in detail. First, the Administrator 110, following consultation with one or more investment banks about current and anticipated pricing conditions for Capital Market Notes 114, including with respect to maturity, yield, interest payment dates and other relevant indicative terms, may periodically communicate with credit unions that satisfy the eligibility criteria to participate about the credit unions' funding plans, the indicative terms for raising funds and whether each credit union would be interested in participating in the next offering, as shown in block 200. Participating Credit Unions 100A-D that notify the Administrator 110 that they wish to participate in the next offering may enter into documentation with the Administrator 110 pursuant to which the Participating Credit Unions 100A-D may agree to sell Share Certificates 112 with a face amount (including accrued interest) not exceeding the SMSIA to one or more Depositor LLCs 102A-D with economic terms that may match those of the Capital Market Notes 114 issued on the settlement date of the next capital markets offering (the “funding date”), except that the rate of interest paid under the Share Certificates 112 may be increased by an amount not to exceed each Participating Credit Union's proportionate share of the fees and expenses incurred in connection with the offering. The number and identity of Participating Credit Unions 100A-D in any particular offering may vary. There is no set formula for credit union participation, and the decision of an eligible credit union to participate in any individual offering may be at the credit union's sole discretion.

All Share Certificates 112 sold to Depositor LLCs 102A-D on any Funding Date may be issued pursuant to standard documentation (containing uniform specified terms and other standardized provisions) and each Depositor LLC 102A-D may purchase a maximum of one Share Certificate 112 from each Participating Credit Union 100A-D. The stated final maturity date of all Share Certificates 112 sold by Participating Credit Unions 100A-D in connection with any offering under the Proposed Program is expected (but not required) to be 3-5 years in duration or longer. The Share Certificates 112 in each Funding Pool (as defined below) are held to maturity.

Certain terms may require that the Depositor LLCs 102A-D collectively use the proceeds from the sale of the Depositor Notes 116 to purchase and hold Share Certificates 112 issued by not fewer than one hundred participating credit unions in order to ensure that any particular offering does not disproportionally benefit a small number of participating credit unions and to encourage the participation of as many eligible credit unions as possible. The Share Certificates 112 purchased by each Depositor LLC 102A-D in connection with a particular offering (each being a “Funding Pool”) may be purchased and held by that Depositor LLC 102A-D as a separate, legally distinct, entity including for deposit insurance purposes, from each other Depositor LLC 102A-D, the Issuer 106, and any Investor 104. All Share Certificates 112 held in a Funding Pool (as defined below) may be held to maturity.

To finance the purchase of the Share Certificates 112, each Depositor LLC 102A-D may issue and sell a Depositor Note 116 to the Issuer 106, which may be secured by such depositor LLC's Funding Pool. To finance the purchase of the Depositor Notes 116, the Issuer 106 may issue Capital Market Notes 114 to the Investors 104. The Capital Market Notes 114 may be secured by the Depositor Notes 116 and the Issuer's secured interest in each depositor LLCs Funding Pool. The Capital Market Notes 114 may be issued as global notes, registered in the name of a nominee of a Depository Trust Company and held by the Indenture Trustee 108 on behalf of the Investors 104. All payments to the Investors 104 of principal, and interest on, the Capital Market Notes 114 may be made by the Issuer 106 through the Depository Trust Company at the direction of the Indenture Trustee 108.

The field of membership for each Participating Credit Union 100A-D may be categorized in a database and then modified if needed to allow each Depositor LLC 102A-D to become a member of each Participating Credit Union 100A-D, as shown in block 202. The modification may require the submission of a specific form that must be approved by the NCUA for the Participating Credit Union 100A-D. The submission and acceptance receipt of the modified field of membership may be automated by the Administrator 110 and maintained in a database for future reference, as shown in block 204. This may be required to validate the NCUA insurance available to credit union members.

Offers to purchase Share Certificates 112 from Participating Credit Unions may then be made, as shown in block 206. Each of the Participating Credit Unions 100A-D may have the option of issuing Share Certificates 112 in a total amount up to $1,000,000, for example (other amounts may be used). Depending on the amount requested, the order may be segregated into 1-4 separate LLCs so that no one LLC has more than a $250,000 balance to maintain NCUA insurance. Confirmed orders from Participating Credit Unions 100A-D each month may be logged into the database, as shown in block 208. The orders may then be separated into an appropriate number of LLCs required to make sure the Share Certificates 112 are fully insured.

The Administrator 110 tracks which Participating Credit Unions 100A-D have sold Share Certificates 112 via the computerized order allocation system 10, as shown in block 210. The database may also be used to identify the Depositor LLC associated with each Share Certificate 112. The amount, rate, and term of each Share Certificate 112 from each Participating Credit Union 100A-D may also be tracked so that the insurance coverage for each Depositor LLC can be verified, documented, and tracked over the life of the Share Certificate 112, as shown in block 212.

### Additional Considerations

The description and drawings are illustrative and are not to be construed as limiting. Numerous specific details are described to provide a thorough understanding. However, in certain instances, well-known or conventional details are not described in order to avoid obscuring the description. References to one embodiment or an embodiment in the present disclosure are not necessarily references to the same embodiment; and, such references mean at least one.

The use of headings herein is merely provided for ease of reference, and shall not be interpreted in any way to limit this disclosure or the following claims.

References to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not for other embodiments. Unless excluded by explicit description and/or apparent incompatibility, any combination of various features described in this description is also included here.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for facilitating capital markets funding, the system comprising:
a plurality of computing devices, each computing device including:
a memory configured to maintain a database of information corresponding to a plurality of credit unions, fields of membership for the credit unions, share certificate orders, and depositor LLCs associated with the share certificate orders;
a processor configured to:
identify participating credit unions of the plurality of credit unions, the participating credit unions indicating interest in participating in a capital markets offering;
modify a field of membership of one of the participating credit unions to allow each of the depositor LLCs to become a member of each of the participating credit unions;
log confirmed share certificate orders;
associate share certificates with a corresponding participating credit union; and
track data relating to each share certificate.

2. The system of claim 1, the data including an amount, rate, and term of each share certificate.

3. The system of claim 1, the database including acceptance receipts of modified fields of membership.

4. The system of claim 1, the processor being further configured to categorize the fields of membership.

5. The system of claim 1, the processor being configured track the data relating to each share certificate for a life of the share certificate.

6. The system of claim 1, wherein the system is operated by an administrator, the administrator being a separate legal entity from the plurality of credit unions and the depositor LLCs.

7. The system of claim 1, wherein modification of the field of membership of one of the participating credit unions includes submission of a form to the one of the participating credit unions.

8. The system of claim 8, wherein submission of the form is automated.

9. The system of claim 1, the processor being further configured to identify the depositor LLC associated with each share certificate.

10. A method of facilitating capital markets funding via a computer implemented system, the method comprising the steps of:
maintaining a database of information corresponding to a plurality of credit unions, fields of membership for the credit unions, share certificate orders, and depositor LLCs associated with the share certificate orders;
identifying participating credit unions of the plurality of credit unions, the participating credit unions indicating interest in participating in a capital markets offering;
modifying a field of membership of one of the participating credit unions to allow each of the depositor LLCs to become a member of each of the participating credit unions;
logging confirmed share certificate orders;
associating share certificates with a corresponding participating credit union; and
tracking data relating to each share certificate.

11. The method of claim 10, the data including an amount, rate, and term of each share certificate.

12. The method of claim 10, further comprising the steps of setting up the depositor LLCs and managing the depositor LLCs.

13. The method of claim 10, further comprising the step of categorizing the fields of membership.

14. The method of claim 10, the step of tracking the data relating to each share certificate including tracking the data for a life of the share certificate.

15. The method of claim 10, the computer implemented system being operated by an administrator, the administrator being a separate legal entity from the plurality of credit unions and the depositor LLCs.

16. The method of claim 10, wherein modification of the field of membership of one of the participating credit unions includes submission of a form to the one of the participating credit unions.

17. The method of claim 16, wherein submission of the form is automated.

18. The method of claim 10, further comprising the step of identifying the depositor LLC associated with each share certificate.

19. The method of claim 10, wherein the step of identifying participating credit unions of the plurality of credit unions is performed monthly.

20. A method of facilitating capital markets funding via a computer implemented system, the method comprising the steps of:
setting up a plurality of depositor LLCs;
managing the plurality of depositor LLCs;
maintaining a database of information corresponding to a plurality of credit unions, fields of membership for the credit unions, share certificate orders, and the depositor LLCs, the database including acceptance receipts of modified fields of membership;
categorizing the fields of membership;
identifying participating credit unions of the plurality of credit unions, the participating credit unions indicating interest in participating in a capital markets offering;
modifying a field of membership of one of the participating credit unions to allow each of the depositor LLCs to become a member of each of the participating credit unions;
logging confirmed share certificate orders;
associating share certificates with a corresponding participating credit union;
identifying the depositor LLC associated with each share certificate; and
tracking data relating to each share certificate for the life of the share certificate, the data including an amount, rate, and term of each share certificate.
